(19) United States
(12) Patent Application Publication
(10) Pub. No.: US 2022/0034141 A1
(43) Pub. Date: Feb. 3, 2022

(54) Finger Saver

(71) Applicant: Erin Marsalisi, Summerville, SC (US)

(72) Inventor: Erin Marsalisi, Summerville, SC (US)

(21) Appl. No.: 16/942,015

(22) Filed: Jul. 29, 2020

(51) Int. Cl. E05F 5/02

(52) U.S. Cl. CPC E05F 5/02

(57) ABSTRACT

Our device will prevent doors/drawers from being fully closed haphazardly. Our invention is new because all objects out there prevent the doors/drawers from being opened while our product solves the unexpected accidents that can occur when those doors/drawers are already open but could cause harm or damage if unintentionally or mindlessly closed. Our product prevents the closing of an object, not the opening of said object.

### BACKGROUND OF THE INVENTION:

This product was invented when I saw a need to protect my daughter's fingers from being crushed when my toddler son slammed the dresser drawer close and she barely got them out in time. From my product research, there are many products to keep drawers closed, but there are not any to prevent accidents from happening when drawers are not locked or are already open.

### BRIEF SUMMARY OF THE INVENTION

The general idea and purpose of this invention is to prevent someone from getting hurt if a drawer or door is unexpectedly closed on them. This product could be used on clothes drawers, doors in houses, doors in cars, and most openings where if someone had their hand on the object and it is accidentally closed with their hand still on said object, the invention would leave enough space so their fingers aren't harmed. Its purpose is to prevent accidents from happening and avoidable harm from occurring.

### BRIEF DESCRIPTION OF THE SEVERAL VIEWS OF THE DRAWINGS

FIG. 1: exterior view of the overall device. One side of the base will have adhesive on it to connect to the drawer/door. Interior block is extended to show that without compression, it will not be level with the base.

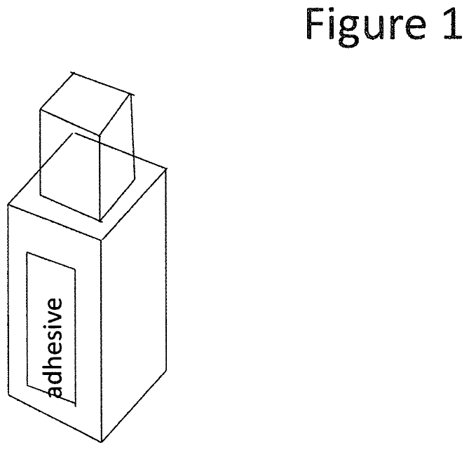

FIG. 2: interior view of the device. It displays the spring which will be connected to the block and the base. The view shows a non-compressed spring with the block being un-level with the base.

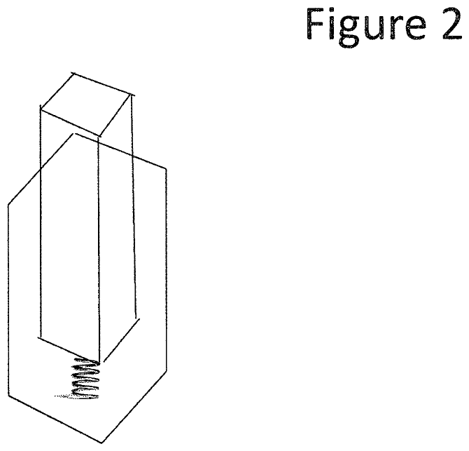

FIG. 3: displays the adhesive on the left-side of base which will connect the base of the product to any object. When the spring is compressed, the block will be level with the base.

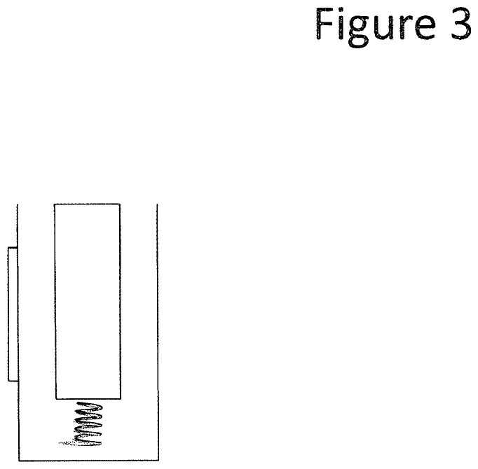

FIG. 4: In this example, the device is attached to a drawer. It displays how when the device's block is compressed, the device will be level with the top of drawer and thus allow the drawer to fully close.

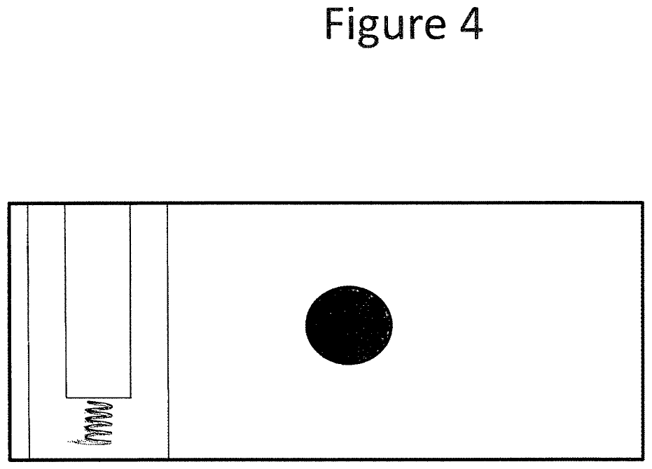

FIG. 5: In this example, the device is attached to a drawer. It displays how when the device's block is not compressed, the device will not be level with top of the drawer and thus not allow the drawer to fully close.

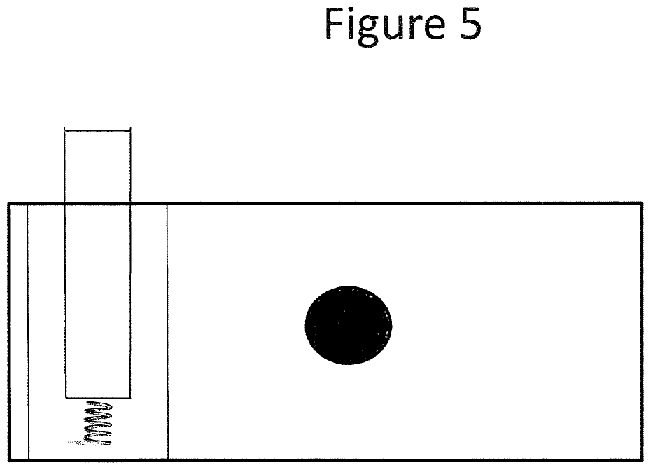

FIG. 6: This figure shows a side view of what the device will look like when attached to a drawer. The block of the device is uncompressed in the open drawer.

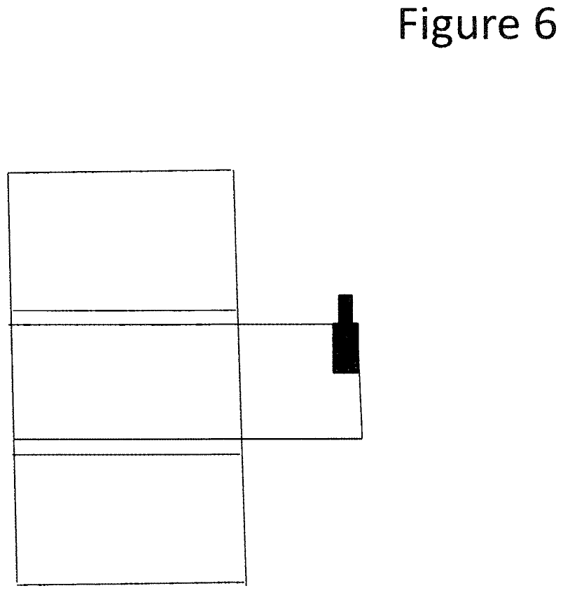

FIG. 7: This figure shows a side view of what the device will look like when attached to a drawer. The block of the device is uncompressed in the open drawer and therefore will not let the drawer be closed until force is used to push the block down and make it level with the device and drawer.

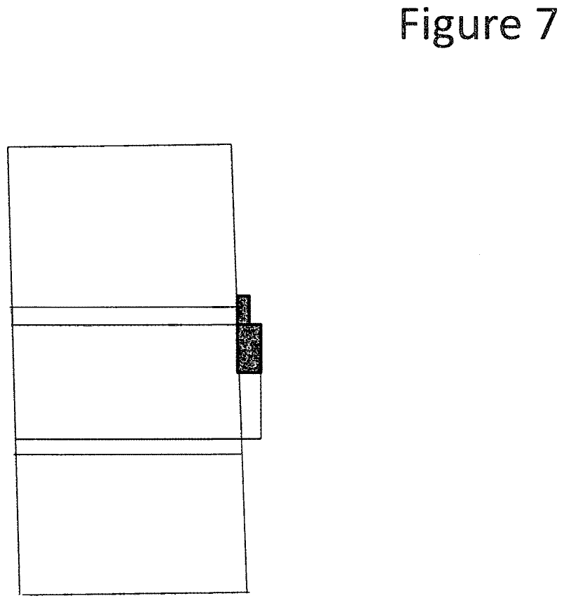

FIG. 8: This figure shows a side view of what the device will look like when attached to a drawer. The block of the device was properly compressed when closed and therefore the drawer is closed and the block is held in compression by the interior of the dresser.

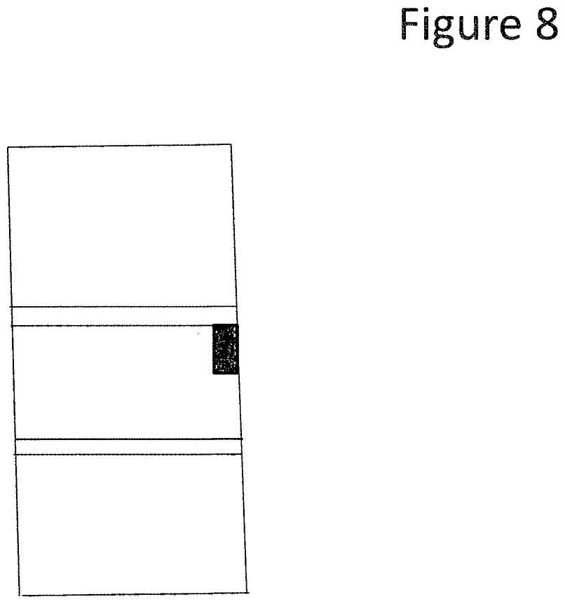

### DETAILED DESCRIPTION OF THE INVENTION:

There are essentially three components to the invention. The first, a base that adheres to the object, ie a door, drawer, etc, that you suspect could possibly harm someone if unexpectedly closed. The second, a block within the base that would prevent the object from closing fully when uncompressed. The third, a spring connected to the base and block that pushes the block out to prevent the object from being closed fully until the spring is pushed down by the block manually so that the object can be safely closed.

1. The scope of our claim is that this device prevents an object from being fully closed. Our subject matter is any door mechanism, whether that door is a door in a home, a door on a car, a drawer in a dresser, and our device is the attachment that prevents that door/drawer from closing.
